(19) United States
(12) Patent Application Publication
(10) Pub. No.: US 2026/0145584 A1
(43) Pub. Date: May 28, 2026

(54) FUEL CELL VEHICLE AND METHOD OF COOLING THE SAME BASED ON ARTIFICIAL INTELLIGENCE

(71) Applicants: Hyundai Motor Company, Seoul (KR); Kia Corporation, Seoul (KR)

(72) Inventor: Hyung Suk BYUN, Hwaseong-Si (KR)

(21) Appl. No.: 19/357,538

(22) Filed: Oct. 14, 2025

(30) Foreign Application Priority Data
Nov. 27, 2024 (KR) 10-2024-0172584

(51) Int. Cl. B60L 58/33; G06N 3/044; G06N 3/092

(52) U.S. Cl. CPC B60L 58/33; G06N 3/044; G06N 3/092; B60L 2240/12; B60L 2240/662

(57) ABSTRACT

Disclosed are a fuel cell vehicle and a method of cooling the same based on artificial intelligence. The artificial intelligence-based cooling method performed by a fuel cell vehicle including a fuel cell discharging product water as a by-product of generation of power, a radiator dissipating heat from cooling water having cooled the fuel cell, and a spray unit spraying the product water to the radiator as spray liquid includes acquiring sets of vehicle information, learning an evaporation rate of the spray liquid evaporated from the radiator for each set of vehicle information changing over time while varying a spray amount of the spray liquid to update a table containing the evaporation rate mapped to each set of vehicle information, adjusting the spray amount so as to maximize the evaporation rate recorded in the updated table, and spraying the spray liquid to the radiator in the adjusted spray amount.

### CROSS-REFERENCE TO RELATED APPLICATION

This application claims the benefit of priority to Korean Patent Application No. 10-2024-0172584, filed in the Korean Intellectual Property Office on Nov. 27, 2024, the entire contents of which are incorporated herein by reference.

### TECHNICAL FIELD

Examples relate to a fuel cell vehicle and a method of cooling the same based on artificial intelligence.

### BACKGROUND

The matters described in this Background section are only for enhancement of understanding of the background of the disclosure, and should not be taken as acknowledgment that they correspond to prior art already known to those skilled in the art.

In order to cope with climate change, eco-friendly vehicles for reduction of carbon emissions are actively being developed around the world. Because most large trucks travel a long distance and require high output, diesel engines are generally mounted in large trucks. Such a diesel engine generates emissions, such as NOx, PM, and carbon dioxide, during fuel combustion, which accelerates global warming. In order to reduce carbon emissions caused by these driving characteristics of trucks, research on eco-friendly vehicles using hydrogen is being conducted.

A fuel cell electric vehicle (FCEV) (hereinafter referred to as a “fuel cell vehicle”) is a vehicle that uses electrical energy generated through a chemical reaction between hydrogen and oxygen as an energy source. In the case of a fuel cell vehicle, no carbon emissions are produced, and the fuel may be easily stored and moved. In addition, a fuel cell vehicle has a shorter charging time and a longer range than other types of eco-friendly vehicles. For these reasons, hydrogen is suitable as a fuel for large trucks. However, a fuel cell vehicle having the above advantages has problems to be solved.

### SUMMARY

Accordingly, examples are directed to a fuel cell vehicle and a method of cooling the same based on artificial intelligence that substantially obviate one or more problems.

Examples provide a fuel cell vehicle and a method of cooling the same based on artificial intelligence capable of efficiently using product water based on artificial intelligence to maximize cooling performance.

However, the objects to be accomplished by the examples are not limited to the above-mentioned objects, and other objects not mentioned herein will be clearly understood by those skilled in the art from the following description.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

According to the present disclosure, a method performed by an apparatus of a vehicle, the method may comprise obtaining a plurality of sets of vehicle information about the vehicle, for each set of the plurality of sets of vehicle information, determining an evaporation rate of spray liquid evaporated from a radiator of the vehicle, wherein the evaporation rate changes over time based on varying a spray amount of the spray liquid, wherein the spray liquid is drawn from product water discharged from a fuel cell of the vehicle as a by-product of generation of power, wherein the radiator is configured to dissipate heat from cooling water having cooled the fuel cell, and wherein the product water is sprayed by a nozzle of the vehicle, as the spray liquid, to the radiator, updating a table of the vehicle recording the evaporation rate, wherein the evaporation rate is mapped to corresponding set of vehicle information of the plurality of sets of vehicle information, adjusting the spray amount so as to maximize the evaporation rate recorded in the updated table, and spraying the product water to the radiator at the adjusted spray amount.

The method, wherein the plurality of sets of vehicle information comprise a driving speed of the vehicle and humidity of air flowing to the radiator.

The method, wherein updating the table may comprise obtaining the evaporation rate based on a recurrent neural network (RNN) using the plurality of sets of vehicle information as an input to the RNN, wherein the RNN may comprise a plurality of nodes, and updating a default value in the table using the evaporation rate, wherein a weight of each of the plurality of nodes of the RNN is adjusted so as to reduce an error as follows: where, RMSE represents the error as a root mean square deviation, m represents a number of times by which the evaporation rate is obtained for each vehicle condition, y(i) represents a maximum amount of heat capable of being dissipated from the radiator by the spray liquid, and represents an actual amount of heat dissipated from the radiator.

The method, wherein the default value in the table is a value determined by experimentally obtaining the evaporation rate in advance for each set of vehicle information of the plurality of sets of vehicle information.

The method, wherein the plurality of sets of vehicle information as the input to the RNN comprise at least one of, a temperature of the cooling water, a flow rate of the cooling water, a temperature of atmosphere around the vehicle, or the spray amount.

The method, wherein the adjusting of the spray amount is performed using a reinforcement learning configured to perform compensation when the evaporation rate is increased and perform penalization when the evaporation rate is decreased.

The method, wherein the adjusting of the spray amount may comprise increasing the spray amount based on the evaporation rate exceeding an upper limit value in the table, reducing the spray amount based on the evaporation rate being less than a lower limit value in the table, and retaining the spray amount based on the evaporation rate being greater than or equal to the lower limit value and less than or equal to the upper limit value.

The method, wherein the adjusting of the spray amount further may comprise updating the table based on the increasing or decreasing of the spray amount.

The method may comprise measuring the spray amount of the spray liquid to the radiator, obtaining, based on the measured spray amount, evaporative latent heat of the spray liquid, measuring a first temperature of cooling water flowing into the radiator and measuring a second temperature of cooling water discharged from the radiator, obtaining an increasing amount of heat dissipation, based on an amount of the cooling water and the first and second temperatures, wherein the increasing amount of heat dissipation corresponds to a difference between heat dissipation amounts before and after spraying the spray liquid, determining whether a ratio of the increasing amount of heat dissipation to the evaporative latent heat is less than a first reference value, and based on the ratio being less than the first reference value, determining the evaporation rate as being less than the lower limit value.

The method may further comprise determining a predicted amount of the cooling water used to obtain the increasing amount of heat dissipation using a map indicating a flow rate for each revolutions per minute of a water pump of the vehicle, and wherein the water pump is configured to pump the cooling water from the fuel cell.

The method may further comprise determining whether the ratio of the increasing amount of heat dissipation to the evaporative latent heat exceeds a second reference value that is greater than the first reference value, based on the ratio exceeding the second reference value, determining the evaporation rate as exceeding the upper limit value.

The method may further comprise, based on the ratio being greater than or equal to the first reference value and less than or equal to the second reference value, determining the evaporation rate as being greater than or equal to the lower limit value and less than or equal to the upper limit value.

According to the present disclosure, a vehicle may comprise a fuel cell configured to discharge product water as a by-product of generation of power, a radiator configured to dissipate heat from cooling water having cooled the fuel cell, a water tank configured to store the product water, a nozzle configured to spray the product water stored in the water tank to the radiator as spray liquid at a flow rate corresponding to a control signal, a controller circuit configured to cause the vehicle to obtain a plurality of sets of vehicle information about the vehicle, for each set of the plurality of sets of vehicle information, determine an evaporation rate of spray liquid evaporated from the radiator, wherein the evaporation rate changes over time based on varying a spray amount of the spray liquid, update a table of the vehicle recording the evaporation rate, wherein the evaporation rate is mapped to corresponding set of vehicle information of the plurality of sets of vehicle information, adjust the spray amount so as to maximize the evaporation rate recorded in the updated table, and output the control signal indicating the adjusted spray amount to the nozzle.

The vehicle, wherein the controller circuit is configured to cause the vehicle to store the table in a memory, retrieve the table stored in the memory and update the retrieved table, adjust the spray amount using the updated table, and generate, based on the adjusted spray amount, the control signal.

The vehicle, wherein the radiator may comprise a first radiator disposed at a front side of the vehicle, wherein the first radiator is configured to be cooled by at least a portion of the spray liquid, and a second radiator disposed behind the first radiator, wherein the second radiator is configured to be cooled by air having passed through the first radiator.

The vehicle, wherein the controller circuit is configured to cause the vehicle to sense humidity of air flowing to the radiator, and measure a driving speed of the vehicle.

The vehicle, wherein the controller circuit is configured to cause the vehicle to sense the spray amount.

According to the present disclosure, a vehicle may comprise a fuel cell configured to generate electrical power and discharge product water, a radiator configured to dissipate heat from cooling water having cooled the fuel cell, a water tank configured to store the product water, a nozzle configured to spray the product water toward the radiator, a controller circuit configured to cause the vehicle to obtain a plurality of sets of vehicle information, for each set of the plurality of sets of vehicle information, based on varying a spray amount of the product water, determine an evaporation rate of the product water sprayed from the nozzle and evaporated from the radiator, update a table mapping the evaporation rate to the corresponding set of vehicle information, adjust, based on the updated table, the spray amount to maximize the evaporation rate, wherein the spray amount is increased based on the evaporation rate exceeding an upper limit value of the table, wherein the spray amount is decreased based on the evaporation rate being less than a lower limit value of the table, and wherein the spray amount is retained based on the evaporation rate being between the lower limit value and the upper limit value, and control the nozzle to spray the product water to the radiator at the adjusted spray amount.

The vehicle, wherein the controller circuit is configured to cause the vehicle to obtain the plurality of sets of vehicle information may comprise at least one of, a driving speed of the vehicle, a humidity of air flowing to the radiator, a temperature of cooling water flowing to the radiator, a flow rate of the cooling water, an ambient temperature of air flowing to the radiator, or a spray amount of the product water.

The vehicle, wherein the evaporation rate indicates an evaporation rate associated with the sprayed product water being turned into vapor after being sprayed to the radiator, and wherein the controller circuit is configured to cause the vehicle to measure a temperature of cooling water flowing into the radiator and a temperature of cooling water discharged from the radiator, based on a flow rate of the cooling water and the measured temperatures of the cooling water, determine an increasing amount of heat dissipation of the radiator, determine a ratio of the increasing amount of heat dissipation to an evaporative latent heat of the sprayed product water, wherein the evaporative latent heat corresponds to an amount of heat required to convert the sprayed product water from a liquid state to a vapor state without a change in temperature of the sprayed product water, and adjust, based on the ratio, the spray amount of the product water.

It is to be understood that both the foregoing general description and the following detailed description of the present disclosure are exemplary and explanatory and are intended to provide further explanation of the disclosure as claimed.

### BRIEF DESCRIPTION

The accompanying drawings, which are included to provide a further understanding of the disclosure and are incorporated in and constitute a part of this application, illustrate example(s) of the disclosure and together with the description serve to explain the principle of the disclosure. In the drawings:

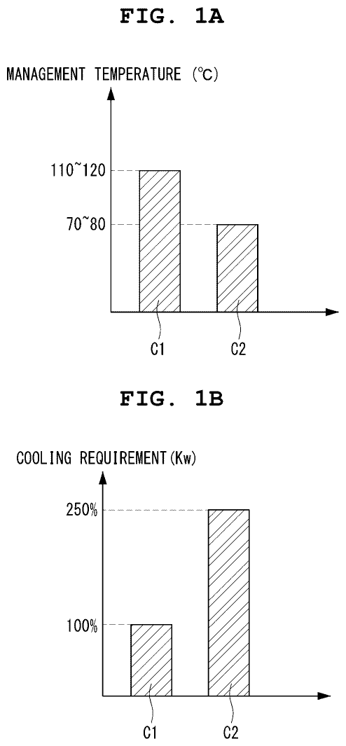

FIG. 1A shows an exemplary comparison between management temperatures required by an internal combustion engine and a fuel cell;

FIG. 1B shows an exemplary comparison between cooling requirements of the internal combustion engine and the fuel cell;

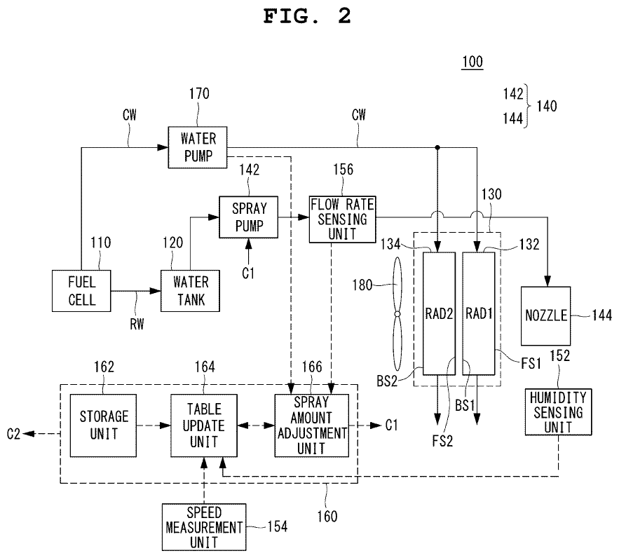

FIG. 2 shows an example a fuel cell vehicle according to an example;

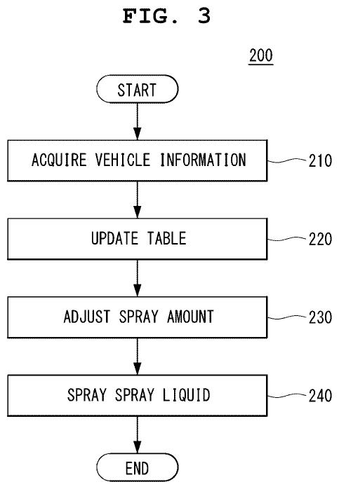

FIG. 3 shows an example of a method of cooling the fuel cell vehicle based on artificial intelligence according to an example;

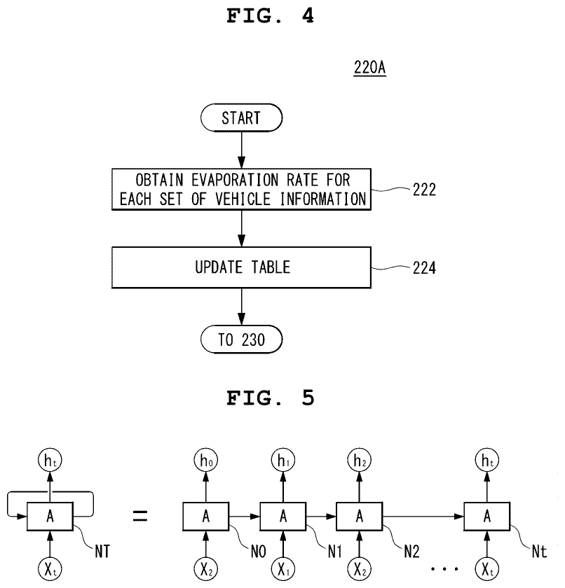

FIG. 4 shows an example of an example of step 220 shown in FIG. 3;

FIG. 5 shows an exemplary recurrent neural network (RNN) according to an example that performs step 222;

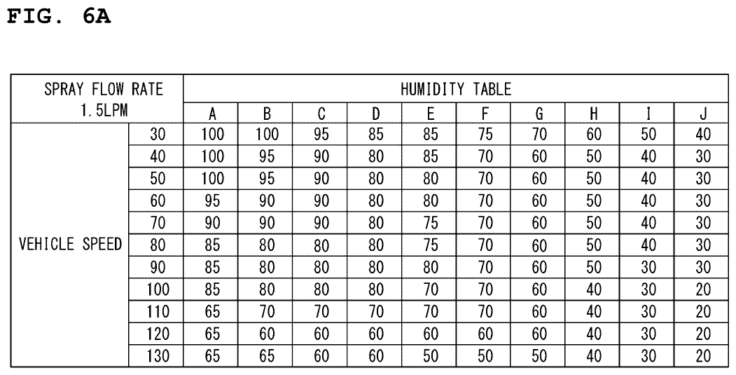

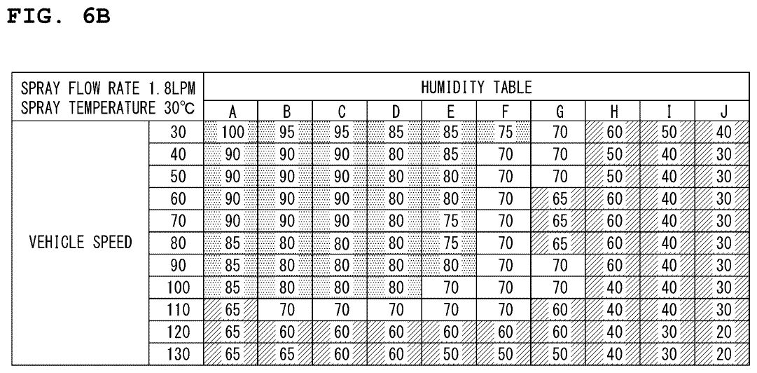

FIG. 6A shows an example of a table in which default values are mapped or a table before being updated;

FIG. 6B shows an example of a table obtained by updating the table shown in FIG. 6A;

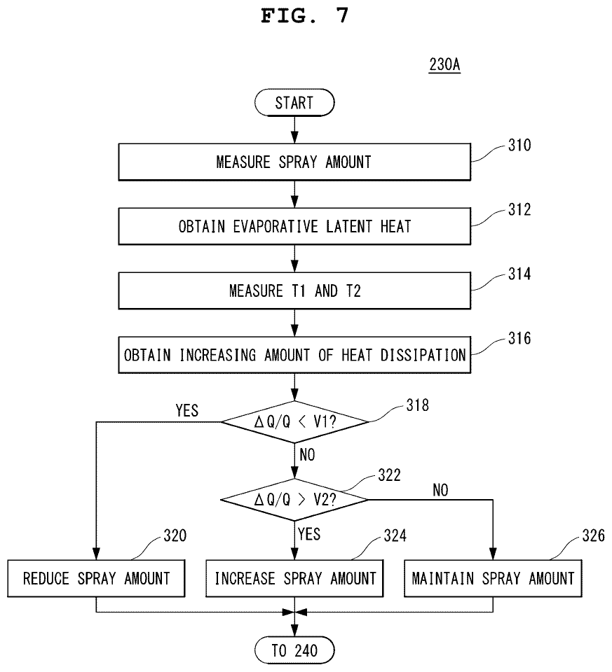

FIG. 7 shows an example of step 230 shown in FIG. 3; and

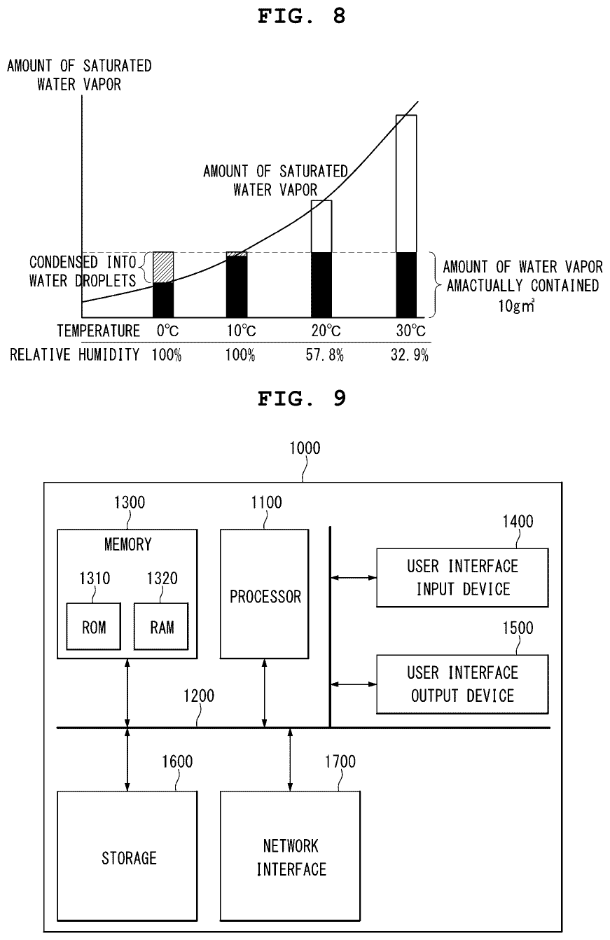

FIG. 8 shows an exemplary graph showing the relationship between an amount of water vapor, temperature, and relative humidity.

FIG. 9 shows an example computing system (e.g., a computing device of a fuel cell vehicle or any other apparatus).

### DETAILED DESCRIPTION

The present disclosure will now be described more fully hereinafter with reference to the accompanying drawings, in which various examples are shown. The examples, however, may be embodied in many different forms, and should not be construed as being limited to the examples set forth herein. Rather, these examples are provided so that this disclosure will be more thorough and complete, and will more fully convey the scope of the disclosure to those skilled in the art.

It will be understood that when an element is referred to as being “on” or “under” another element, it may be directly on/under the element, or one or more intervening elements may also be present.

When an element is referred to as being “on” or “under”, “under the element” as well as “on the element” may be included based on the element.

In addition, relational terms, such as “first”, “second”, “on/upper part/above”, and “under/lower part/below”, are used only to distinguish between one subject or element and another subject or element, without necessarily requiring or involving any physical or logical relationship or sequence between the subjects or elements.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components s such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICS, DSPS, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system.

Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., vehicle condition-based adaptive radiator cooling control using artificial intelligence and product water from a fuel cell) described herein, an operation of the vehicle may be controlled.

The vehicle control may include various operational controls associated with the vehicle (e.g., autonomous driving control, sensor control, braking control, braking time control, acceleration control, acceleration change rate control, alarm timing control, forward collision warning time control, etc.). One or more auxiliary devices (e.g., engine brake, exhaust brake, hydraulic retarder, electric retarder, regenerative brake, etc.) may also be controlled, for example, based on one or more features (e.g., vehicle condition-based adaptive radiator cooling control using artificial intelligence and product water from a fuel cell) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., vehicle condition-based adaptive radiator cooling control using artificial intelligence and product water from a fuel cell) described herein.

Minimum risk maneuver (MRM) operation(s) may also be controlled, for example, based on one or more features (e.g., vehicle condition-based adaptive radiator cooling control using artificial intelligence and product water from a fuel cell) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time. Biased driving operation(s) may also be controlled, for example, based on one or more features (e.g., vehicle condition-based adaptive radiator cooling control using artificial intelligence and product water from a fuel cell) described herein.

A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc. One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., vehicle condition-based adaptive radiator cooling control using artificial intelligence and product water from a fuel cell) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.). An autonomous driving level and/or autonomous driving activation/deactivation may also be controlled, for example, based on one or more features (e.g., vehicle condition-based adaptive radiator cooling control using artificial intelligence and product water from a fuel cell) described herein.

A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

According to the present disclosure, a fuel cell vehicle is configured to improve cooling performance by utilizing water generated during power production in the fuel cell. The vehicle may include a system that sprays the water onto a radiator to enhance heat dissipation through evaporation. Because cooling requirements may vary with factors such as vehicle speed, ambient humidity, and coolant temperature, an artificial intelligence control approach (e.g., a recurrent neural network (RNN), reinforcement learning, etc.) is used to determine and adjust an optimal spray amount in real time. The system may obtain vehicle condition information, learn evaporation rates for different conditions, update a table mapping evaporation rates to the conditions, and adjust the spray amount to increase or maximize cooling efficiency. Measurements such as spray flow rate, coolant inlet and outlet temperatures, and fan speed may be used to refine control parameters. By enhancing or optimizing the evaporative cooling effect, the system may increase cooling efficiency, reduce the required size and capacity of the radiator and fan, conserve stored water, improve energy efficiency and vehicle range, and prevent unnecessary water discharge that could cause road icing in cold weather.

Hereinafter, a fuel cell vehicle (hereinafter referred to as a “vehicle”) 100 and a method 200 of cooling the same based on artificial intelligence according to examples will be described with reference to the accompanying drawings.

FIG. 1A shows an exemplary comparison between management temperatures required by an internal combustion engine C1 and a fuel cell C2, and FIG. 1B shows an exemplary comparison between cooling requirements of the internal combustion engine C1 and the fuel cell C2.

Referring to FIG. 1A, the temperature of the internal combustion engine C1 may be managed to fall within a range of 110° C. to 120° C., and the temperature of the fuel cell C2 may be managed to fall within a range of 70° C. to 80° C. A difference between the management temperature of the fuel cell C2 and an outside temperature of a vehicle is smaller than a difference between the management temperature of the internal combustion engine C1 and an outside temperature of a vehicle. Therefore, if a cooling module for use in the internal combustion engine C1 is applied to the fuel cell C2, cooling performance may be degraded. Further, unlike the internal combustion engine C1, the fuel cell C2 may not have exhaust system. Therefore, in the case of the fuel cell C2, about 50% of input energy is discharged as cooling heat, and accordingly, a cooling requirement is high, as shown in FIG. 1B. In consideration thereof, in the case of a fuel cell vehicle equipped with the fuel cell C2, the size and the number of cooling modules for cooling a cell stack of the fuel cell are increased.

Furthermore, as a fuel cell vehicle is motorized, it may also cool a motor, a power electric (PE) module, an automatic transmission (ATM), and a high-voltage battery, as well as a fuel cell. For example, the number of parts to be cooled in a vehicle equipped with the fuel cell C2 (e.g., twenty to thirty) may be about five times as large as that in a vehicle equipped with the internal combustion engine C1 (e.g., four to six). In the case of a fuel cell vehicle, in which the number of parts to be cooled is relatively large, there may be a limitation on the extent to which the size of a cooling module is increased due to the limited size of the fuel cell vehicle. Further, considering a passenger compartment, a storage space, and a payload, the size of the space occupied by a cooling system in a fuel cell vehicle is, for example, at least three or four times as large as that in a vehicle equipped with an internal combustion engine, e.g., a diesel engine. Therefore, increasing or maximizing cooling performance in a limited space in a fuel cell vehicle is considered according to the present disclosure.

FIG. 2 shows an example the fuel cell vehicle 100 according to the example.

The vehicle 100 may include a fuel cell 110, a water tank (or a reservoir tank) 120, a radiator 130, a spray unit 140, information acquisition units 152, 154, and 156, and a controller 160. In addition, the vehicle 100 may further include a water pump 170. In addition, the vehicle 100 may further include a fan 180, and in some examples, additional auxiliary cooling components (e.g., coolant distribution manifolds, heat exchangers, intercoolers, or temperature control valves, etc.) may be provided to improve thermal management.

In FIG. 2, lines interconnecting the components 110, 120, 130, 140, and 170 may correspond to pipes through which liquid flows (e.g., stainless steel pipes, reinforced rubber hoses, composite conduits, or flexible corrugated tubing, etc.).

The fuel cell 110 may be a component from which heat is generated when the fuel cell vehicle 100 is driven. The fuel cell 100 may be, for example, a polymer electrolyte membrane fuel cell (or a proton exchange membrane fuel cell) (PEMFC), which has been studied most extensively as a power source for driving vehicles (e.g., passenger cars, buses, heavy-duty trucks, or forklifts, etc.). The fuel cell 110 may include end plates (not shown), current collectors (not shown), and a cell stack (not shown). The cell stack may include a plurality of unit cells that are stacked one above another. Because the respective components of the fuel cell, such as the current collectors and the end plates, are well known in the art, a detailed description thereof will be omitted.

For example, product water (reaction water or condensate water) RW generated as a by-product during reaction between hydrogen and oxygen for generation of power in the fuel cell 110 may be discharged to the water tank 120. The water tank 120 serves to store the product water RW as spray liquid for use in cooling operations (e.g., radiator evaporative cooling, intercooler spray cooling, or auxiliary heat exchanger cooling, etc.).

The product water RW may have a temperature of 60° C. or lower, for example, 57° C. to 58° C., and may be discharged from the fuel cell 110 at a rate of 0.5 to 0.6 liter per minute (LPM). However, the examples are not limited as to the specific temperature or discharge rate of the product water RW (e.g., the temperature may be lower in cold ambient conditions, or the discharge rate may be higher during peak fuel cell load conditions, etc.).

The radiator 130 serves to dissipate heat from cooling water CW, which has received heat generated during a power generation process in the fuel cell 110 to cool the fuel cell 110, to the atmosphere outside the vehicle 100. The radiator 130 may correspond to a heat dissipator, a heat dissipating device, or a heat sink (e.g., a crossflow radiator, a downflow radiator, or a multi-pass radiator, etc.). However, the examples are not limited as to the specific type or number of radiators 130 or the presence/absence or specific type of the fan 180 to be described later.

The fuel cell 110 may discharge cooling water CW that has absorbed heat generated during power generation, and may supply the discharged cooling water CW to the radiator 130. For example, if cooling water CW having a temperature of 75° C. to 80° C. flows into the radiator 130 and then discharges heat from the radiator 130 to the outside, the cooling water with the temperature lowered to 65° C. to 70° C. may be discharged from the radiator 130 and supplied back to the fuel cell 110 (e.g., through a coolant return line, via a pump-assisted loop, or by gravity feed in certain configurations, etc.).

The radiator 130 may include first and second radiators RAD1 and RAD2 arranged in series so as to be spaced apart from each other in the heading direction of the vehicle 100. However, the examples are not limited as to the specific number of radiators 130 (e.g., a single large radiator, a triple-radiator arrangement, or parallel-flow radiators, etc.).

The first radiator RAD1 may be disposed at a front side of the fuel cell vehicle 100 and may be directly cooled by spray liquid. The second radiator RAD2 may be disposed behind the first radiator RAD1 and may be cooled by air that has passed through the first radiator RAD1 (e.g., assisted by a mechanical fan, an electric fan, or vehicle forward motion, etc.).

The first radiator RAD1 may include a first front surface FS1 facing a nozzle 144 of the spraying unit 140 and a first rear surface BS1 formed opposite the first front surface FS1. The second radiator RAD2 may include a second front surface FS2 facing the first rear surface BS1 of the first radiator RAD1 and a second rear surface BS2 formed opposite the second front surface FS2 (e.g., each surface may be formed of aluminum fins, copper tubes, or composite heat-dissipating panels, etc.).

The fan 180 is disposed so as to face the second rear surface BS2 of the second radiator RAD2. The fan 180 serves to control the flow of air to the radiator 130 and/or the flow of air from the radiator 130 (e.g., by operating at variable speeds, reversing airflow direction, or modulating blade pitch, etc.).

The spray unit 140 serves to spray water to the radiator 130. That is, the spray unit 140 serves to spray the product water RW stored in the water tank 120 to the radiator 130 as spray liquid in an amount corresponding to a first control signal C1 (e.g., a signal generated by the controller based on vehicle speed, coolant temperature, or ambient humidity, etc.). To this end, the spray unit 140 may include a spray pump 142 and a nozzle 144 (e.g., a high-pressure misting nozzle, a flat-fan nozzle, or a multi-jet spray head, etc.).

The spray pump 142 may operate in response to the first control signal C1 to supply the spray liquid stored in the water tank 120 to the nozzle 144, and the nozzle 144 may spray the product water RW to the first radiator RAD1 as spray liquid (e.g., in a fine mist, a controlled stream, or a pulsed spray pattern, etc.).

FIG. 3 shows an example of the method 200 of cooling the fuel cell vehicle based on artificial intelligence according to the example.

Hereinafter, the method 200 shown in FIG. 3 will be described as being performed by the vehicle 100 shown in FIG. 2, and the vehicle 100 shown in FIG. 2 will be described as performing the method 200 shown in FIG. 3. However, the examples are not limited thereto. That is, the following description may also be applied to a case in which the vehicle 100 shown in FIG. 2 performs a method configured differently from the method 200 shown in FIG. 3, and the method 200 shown in FIG. 3 may also be applied to a vehicle configured differently from the vehicle 100 shown in FIG. 2 (e.g., a different type of hydrogen-powered vehicle, a hybrid electric vehicle, or a vehicle with an alternative cooling architecture, etc.).

According to the cooling method 200 of the example, vehicle information is first acquired (step 210). Step 210 may be performed by the information acquisition units. That is, the information acquisition units may acquire vehicle information (e.g., operating parameters, sensor readings, or environmental conditions, etc.).

For example, the vehicle information may include a driving speed of the fuel cell vehicle 100 and humidity (e.g., relative humidity, absolute humidity, or dew point, etc.) of air that is introduced into the front side of the vehicle and flows to the radiator 130. In this case, the information acquisition units may include a humidity sensing unit 152 and a speed measurement unit 154 (e.g., a GPS-based speed sensor, a wheel speed sensor, or a radar-based velocity detector, etc.).

The humidity sensing unit 152 may sense the humidity of air that is introduced into the front side of the vehicle and flows to the radiator 130, and may output a result of the sensing to the controller 160. To this end, the humidity sensing unit 152 may be disposed adjacent to the first radiator RAD1 (e.g., in front of the radiator core, within an intake duct, or integrated into a grille-mounted sensor housing, etc.).

The speed measurement unit 154 may measure the driving speed of the fuel cell vehicle 100, and may output the measured speed to the controller 160 (e.g., via a Controller Area Network (CAN) bus, a dedicated sensor interface, or wireless telemetry, etc.).

After step 210, the controller learns the evaporation amount of spray liquid evaporated from the radiator 130 for each set of vehicle information that changes over time while varying the spray flow rate (hereinafter referred to as a “spray amount”) of the spray liquid, and updates a table in which the evaporation amount is mapped to each set of vehicle information (step 220) speed-humidity (e.g., mapping, temperature-humidity mapping, or cooling water temperature-spray amount mapping, etc.).

FIG. 4 shows an example of an example 220A of step 220 shown in FIG. 3.

After step 210, the evaporation amount of the spray liquid evaporated from the radiator 130 is obtained through a recurrent neural network (RNN) using vehicle information as an input (step 222) (e.g., time-series data of speed, humidity, and coolant temperature used to predict optimal spray performance, etc.).

FIG. 5 shows an exemplary recurrent neural network (RNN) according to an example that performs step 222.

In FIG. 5, data (hereinafter referred to as “input data”) X0 to Xt input to nodes(or, networks) A (N0 to Nt) may represent vehicle information, and data (hereinafter referred to as “output data”) h0 to ht output from the nodes A (N0 to Nt) may correspond to an evaporation rate (evaporation amount or evaporation degree) (e.g., percentage of sprayed product water fully evaporated, or efficiency of heat removal due to evaporation, etc.).

According to the example, the vehicle information corresponding to the input data X0 to Xt input to the nodes A (N0 to Nt) may be the driving speed of the vehicle 100 and the humidity described above. Alternatively, the input data X0 to Xt may include at least one of the driving speed, the humidity, the temperature of the cooling water CW, the flow rate of the cooling water CW, the temperature of the atmosphere around the vehicle (e.g., outside air flowing to the radiator 130), or the spray amount (e.g., outside air flowing to the radiator 130, air temperature near the condenser, or intake duct air temperature, etc.). According to the example, the vehicle information, such as the driving speed of the vehicle, the humidity, the temperature of the cooling water, and the flow rate of the cooling water, is a factor that changes in real time, and may be learned in time series through the RNN.

This vehicle information may be a controller area network (CAN) signal that is transmitted to the controller 160 through CAN communication (e.g., from an engine control unit (ECU), a body control module (BCM), or a thermal management control unit, etc.).

For example, a weight w of each of the nodes A (N0 to Nt) of the RNN may be optimized so as to minimize an error, as shown in Equation 1 below (e.g., by iteratively adjusting the weights during training, by applying stochastic gradient descent, or by using adaptive learning rate optimizers, etc.).

$$RSME = \sqrt{\frac{1}{m} {\sum }_{i = 1}^{m} {‖ {y}^{( i )} - {\hat{y}}^{( i )} ‖}^{2}} \qquad [ Equation 1 ]$$

Here, RMSE represents the error as a root mean square deviation, m represents the number of times by which the evaporation amount is obtained for each vehicle condition, y⁽ⁱ⁾ represents the maximum amount of heat capable of being dissipated from the radiator 130 by the spray liquid, and ŷ⁽ⁱ⁾ represents an actual amount of heat dissipated from the radiator 130 (e.g., measured via coolant temperature sensors, calculated from airflow and thermal transfer coefficients, or obtained from integrated heat flux sensors, etc.).

The heat dissipation amounts y⁽ⁱ⁾ and may be ŷ⁽ⁱ⁾ obtained from the evaporation rates corresponding to the output data h0 to ht shown in FIG. 5 (e.g., by correlating percentage of water evaporated to the corresponding thermal energy removed from the radiator surfaces, etc.).

Equation 1 may be a type of error function of the RNN, and the error may be reduced through a gradient descent method (e.g., batch gradient descent, mini-batch gradient descent, or online gradient descent, etc.).

After step 222, the default value in the table is updated using the evaporation rate (step 224). The default value will be described later (e.g., default mapping of speed and humidity to expected evaporation performance before AI-based adjustments, etc.).

Referring again to FIGS. 2 and 3, in order to perform step 220, the controller 160 may include a storage unit 162 and a table update unit 164 (e.g., implemented as embedded flash memory, solid-state storage, or external high-speed memory modules, etc.).

The storage unit 162 may store the table, and the table update unit 164 may read the table stored in the storage unit 162, and may update the read table through steps 222 and 224 (e.g., by overwriting entries, appending updated values, or maintaining historical versions for diagnostics, etc.).

The default value initially stored in the storage unit 162 is a value determined by experimentally obtaining the evaporation rate in advance for each set of vehicle information before performing step 222 (e.g., through wind tunnel testing, controlled climate chamber experiments, or on-road performance trials, etc.).

FIG. 6A shows an example of a table in which default values are mapped or a table before being updated, and FIG. 6B shows an example of a table obtained by updating the table shown in FIG. 6A.

For example, when the vehicle information includes the vehicle speed and the humidity, the tables shown in FIGS. 6A and 6B may show the relationship between the spray amount, the vehicle speed, the humidity A to J, and the evaporation amount. Here, the humidity increases from A to J. That is, humidity A is the lowest, and humidity J is the highest (e.g., humidity A may correspond to dry desert conditions, while humidity J may correspond to tropical, moisture-saturated air, etc.)

The table having the default values shown in FIG. 6A may be read from the storage unit 162, and may then be learned through the RNN so as to minimize the error, as shown in Equation 1 above. Therefore, the table shown in FIG. 6A may be updated to the table shown in FIG. 6B (e.g., reflecting improved evaporation rate predictions for given environmental and operating conditions, etc.).

The vehicle speed included in the vehicle information may change over time. For example, in FIG. 5, when, as the input data X0 at a certain time point t0, the vehicle speed is 30 km/h (kph) and the temperature of the cooling water CW is 75° C. and when the flow rate of the cooling water, the outside temperature, and the spray amount are provided as the input data X0, the output data h0 may be an evaporation rate of 50% (e.g., indicating half of the sprayed product water evaporates under those conditions, etc.).

In addition, when, as the input data X1 at a certain time point t1 after the time point t0, the vehicle speed is 50 kph and the temperature of the cooling water CW is 75° C., the output data h1 may be an evaporation rate of 30% (e.g., reduced evaporation efficiency due to higher airflow carrying away spray before full heat transfer, etc.).

In addition, when, as the input data X2 at a certain time point t2 after the time point t1, the vehicle speed is 70 kph and the temperature of the cooling water CW is 85° C., the output data h2 may be an evaporation rate of 70% (e.g., improved evaporation due to higher coolant temperature increasing latent heat transfer, etc.).

In this way, the table indicating the evaporation rate for each set of vehicle information may be learned and updated in real time using the RNN shown in FIG. 5 (e.g., enabling adaptive optimization for changing road grades, ambient conditions, or driving patterns, etc.).

After step 220, the controller 160 adjusts the spray amount so that the evaporation rate recorded in the updated table is maximized (step 230). To this end, the controller 160 may include a spray amount adjustment unit 166. The spray amount adjustment unit 166 may adjust the spray amount so that the evaporation rate recorded in the updated table is maximized, and may output a first control signal C1 generated corresponding to the adjusted spray amount to the spray pump 142 of the spray unit 140 (e.g., to increase mist density during high heat load or reduce spray during low load conditions, etc.).

For example, the step of adjusting the spray amount may be performed using a reinforcement learning method that performs compensation when the evaporation rate is improved and performs penalization when the evaporation rate is deteriorated (e.g., increasing water flow when model performance metrics exceed thresholds, or decreasing flow when excess water is wasted without additional cooling benefit, etc.).

According to the example, the step of adjusting the spray amount may be a step that increases the spray amount if the evaporation rate exceeds the maximum value in the table and reduces the spray amount if the evaporation rate is less than the minimum value in the table. In addition, if the evaporation rate is greater than or equal to the minimum value and less than or equal to the maximum value in the table, the spray amount may be retained or maintained (e.g., maintaining stable control to prevent oscillations in spray output, etc.).

For example, if the cooling performance and the evaporation rate when the vehicle information such as the vehicle speed and the humidity is not reflected are 100% and 70%, respectively, the spray amount may be adjusted through reinforcement learning that performs compensation of increasing the spray amount when the cooling performance is improved to 120% and the evaporation rate is 90% and performs penalization of reducing the spray amount when the cooling performance is deteriorated to 80% and the evaporation rate is 50% (e.g., achieving a balance between cooling efficiency, water conservation, and system durability, etc.).

FIG. 7 shows an example 230A of step 230 shown in FIG. 3.

Step 230A shown in FIG. 7 may be performed by the information acquisition units and the spray amount adjustment unit 166 (e.g., a humidity sensing unit, a speed measurement unit, or a flow rate sensing unit).

After step 220, the spray amount of the spray liquid to the radiator 130 is measured (step 310). To this end, the information acquisition units may further include a flow rate sensing unit 156. The flow rate sensing unit 156 may sense the spray amount, and may output a result of the sensing to the spray amount adjustment unit 166.

After step 310, the evaporative latent heat of the spray liquid is obtained using the measured spray amount (step 312). For example, the evaporative latent heat may be obtained using Equation 2 below (e.g., applying the formula to different spray amounts and temperatures).

$$Q = M \times r \qquad [ Equation 2 ]$$

Here, Q represents the evaporative latent heat, M represents the spray amount, and r represents the amount of heat required for state change. For example, when the spray amount M is 1.6 LPM, the evaporative latent heat becomes 65 kw, as shown in the Equation 3 below.

$$Q = ( 1.6 / 60 ) ( kg / s ) \times ( 583 \times 4.186 ) ( kcal / kg ) = 65 kW \qquad [ Equation 3 ]$$

After step 312, the temperature (hereinafter referred to as a “first temperature”) T1 of the cooling water CW flowing into the radiator 130 and the temperature (hereinafter referred to as a “second temperature”) T2 of the cooling water discharged from the radiator 130 are measured (step 314). For example, the first temperature T1 may have a range of 75° C. to 80° C., the second temperature T2 may have a range of 65° C. to 70° C., and the temperature of the outside air may have a range of 35° C. to 40° C. (e.g., during hot summer operation in urban traffic).

After step 314, an increasing amount of heat dissipation, which corresponds to a difference between heat dissipation amounts before and after spraying the spray liquid, is obtained using the flow rate of the cooling water (hereinafter referred to as the “amount of cooling water”) and the first and second temperatures T1 and T2, as shown in Equation 4 below (step 316).

$$Δ Q = QA - QB \qquad [ Equation 4 ]$$

Here, ΔQ represents the increasing amount of heat dissipation, QA represents the heat dissipation amount after spraying the spray liquid, and QB represents the heat dissipation amount before spraying the spray liquid. Each of QA and QB may be obtained using Equation 5 below (e.g., substituting actual measured flow rates and specific heat values).

$$QT = C \times M \times dT ( T 1 - T 2 ) \qquad [ Equation 5 ]$$

Here, QT represents QA or QB, C represents specific heat, and M represents the mass flow rate of the cooling water.

According to the example, the amount of cooling water used when obtaining the increasing amount of heat dissipation may be predicted using a map indicating a flow rate for each RPM (revolutions per minute) of the water pump 170. The water pump 170 serves to pump the cooling water CW from the fuel cell 110 and supply the cooling water CW to the radiator 130. For example, as shown in FIG. 2, the water pump 170 may be disposed on a path between the fuel cell 110 and the radiator 130 (e.g., connected via an inlet pipe and an outlet pipe). Alternatively, unlike the configuration shown in FIG. 2, the water pump 170 may be disposed inside the fuel cell 110 (e.g., integrated into a cooling module).

The spray amount adjustment unit 166 may store a flow rate map shown in Table 1 below in advance, may check the RPM (revolutions per minute) of the water pump (or coolant supply pump (CSP)) 170, and then may recognize the flow rate of the cooling water corresponding to the checked RPM.

TABLE 1

| CSP RPM | 1,000 | 2,000 | 3,000 | 4,000 | 5,000 | 6,000 |
|---|---|---|---|---|---|---|
| Radiator | 35 | 60 | 95 | 120 | 154 | 180 |
| Flow Rate | | | | | | |
| (LPM) | | | | | | |

Here, “Radiator Flow Rate” represents the flow rate (or amount) of the cooling water flowing into the radiator 130 (e.g., measured in liters per minute using a flow sensor)

After step 316, whether a ratio of the increasing amount of heat dissipation ΔQ to the evaporative latent heat Q (ΔQ/Q) is less than a first reference value V1 is determined (step 318).

If the ratio of the increasing amount of heat dissipation ΔQ to the evaporative latent heat Q (ΔQ/Q) is less than the first reference value V1, the evaporation amount is determined to be less than the minimum value, and the spray amount is correspondingly reduced (step 320).

If the ratio of the increasing amount of heat dissipation ΔQ to the evaporative latent heat Q (ΔQ/Q) is greater than or equal to the first reference value V1, whether the ratio of the increasing amount of heat dissipation ΔQ to the evaporative latent heat Q (ΔQ/Q) exceeds a second reference value V2 is determined (step 322). Here, the second reference value V2 may be greater than the first reference value V1. For example, the first reference value V1 may be 70%, and the second reference value V2 may be 90%. However, the examples are not limited to any specific values of the first and second reference values V1 and V2 and different thresholds may be used depending on vehicle cooling requirements or environmental conditions.

If the ratio of the increasing amount of heat dissipation ΔQ to the evaporative latent heat Q (ΔQ/Q) exceeds the second reference value V2, the evaporation amount is determined to exceed the maximum value, and the spray amount is increased (step 324).

If the ratio of the increasing amount of heat dissipation ΔQ to the evaporative latent heat Q (ΔQ/Q) is greater than or equal to the first reference value V1 and less than or equal to the second reference value V2, the evaporation amount is determined to be greater than or equal to the minimum value and less than or equal to the maximum value, and the spray amount is maintained or kept constant (step 326), for example, at 100% of the current spray setting.

For example, when the spray amount of the spray liquid, which is a current adjustment target, is 100%, if the ratio of the increasing amount of heat dissipation ΔQ to the evaporative latent heat Q (ΔQ/Q) is less than the first reference value V1, the spray amount may be reduced to 80%, if the ratio of the increasing amount of heat dissipation ΔQ to the evaporative latent heat Q (ΔQ/Q) exceeds the second reference value V2, the spray mount may be increased to 120%, and if the ratio of the increasing amount of heat dissipation ΔQ to the evaporative latent heat Q (ΔQ/Q) is greater than or equal to the first reference value V1 and less than or equal to the second reference value V2, the spray amount may be maintained at 100%.

In this case, the spray amount adjustment unit 166 may update the table so as to reflect the increased or reduced spray amount (e.g., overwriting the previous value for the same speed-humidity combination).

For example, the table shown in FIG. 6A is assumed to correspond to a previously updated table. In this case, the evaporation rate is learned to be 95% under the conditions of the spray amount being 1.5 LPM, the vehicle speed being 50, and the humidity being B. In this case, if the ratio of the increasing amount of heat dissipation ΔQ to the evaporative latent heat Q (ΔQ/Q) exceeds the second reference value V2, the spray amount may be increased by 0.3 LPM so as to be 1.8 LPM, and learning may be performed again (e.g., resulting in an updated evaporation rate). In this case, the table may be updated as shown in FIG. 6B.

According to the above-described method using artificial intelligence, all the parts marked in the hatched lines in FIG. 6B may be marked in the dots.

Referring again to FIGS. 2 and 3, after step 230, the spray liquid is sprayed to the radiator 130 in the adjusted spray amount (step 240). Step 240 is performed by the spray unit 140. That is, the spray unit 140 may control the flow rate pumped by the spray pump 142 through the first control signal C1 so that the product water RW stored in the water tank 120 is supplied to the radiator 130 in the spray amount determined by the spray amount adjustment unit 166. In this case, the nozzle 144 sprays the product water RW discharged from the spray pump 142 to the radiator 130 as the spray liquid (e.g., in a fine mist pattern or a coarse droplet pattern depending on control settings).

In addition, the controller 160 may request a decrease in the RPM of the fan 180 through a second control signal C2 when implementing inter-seasonal evaporative cooling (e.g., during mild spring or autumn temperatures to reduce energy consumption).

When implementing evaporative cooling on the radiator 130 using the spray liquid according to the method 200 of cooling the fuel cell vehicle according to the above-described example, the heat dissipation performance of the first radiator RAD1 may be improved by 50%, and the heat dissipation performance of the second radiator RAD2 may be improved by 40%.

Hereinafter, a comparative example and the method of cooling the fuel cell vehicle according to the example will be described (e.g., to highlight the efficiency difference between conventional air cooling and evaporative cooling).

FIG. 8 shows an exemplary graph showing the relationship between an amount of water vapor, temperature, and relative humidity. In FIG. 8, the horizontal axis represents relative humidity and temperature, and the vertical axis represents an amount of saturated water vapor (e.g., expressed in grams of water per cubic meter of air).

In general, the amount of air that is introduced into the front side of the vehicle and flows to the front surface of the radiator (also referred to as “front air”) is varied depending on the vehicle speed (e.g., low airflow at 20 km/h and high airflow at 100 km/h). Accordingly, an area of the radiator to which the spray liquid is sprayed (hereinafter referred to as a “spray area”) and the size of the particles of the spray liquid are changed (e.g., spray coverage from 50% to 100%, and droplet diameter from 50 μm to 200 μm), whereby the thickness of water on the surface of the radiator 130 is changed (e.g., forming a thin film under low spray and a thicker film under high spray). Therefore, under these conditions, it is impossible to quantitatively analyze the improvement in the evaporation rate. The humidity of air has a large influence on the evaporation rate. That is, as illustrated in FIG. 8, evaporation occurs well under the condition of low relative humidity, but hardly occurs under the condition of high relative humidity.

In addition, according to the comparative example, there is no humidity sensor outside the vehicle, and the correlation with the evaporation rate is not linear. Thus, it is quite difficult to control the water spray amount in a manner of optimizing the evaporation rate according to the vehicle driving conditions (e.g., low-speed urban driving, high-speed highway driving, uphill climbing, or stop-and-go traffic) and the relative humidity (e.g., 20%, 50%, or 80%).

Moreover, even under the condition of equivalent humidity, the evaporation rate changes due to slight differences in size between the particles of sprayed water (e.g., fine mist, medium droplets, or coarse spray). As described above, it is difficult to use variables, such as precise droplet size, instantaneous airflow turbulence, or micro-temperature gradients, which are difficult to obtain, as input factors for the spray amount in order to address the nonlinear issue. Therefore, according to the example, as shown in FIG. 5, the evaporation rate for each set of vehicle information (e.g., driving conditions) (e.g., driving speed, ambient temperature, and humidity) is obtained through time-series learning (learning of the evaporation rate for each vehicle speed using the vehicle speed, which is CAN data, as an input factor).

If learning is advanced in this way, when the driving conditions change (e.g., increase or decrease in the vehicle speed) (e.g., a sudden acceleration from 40 km/h to 80 km/h, a deceleration for traffic lights, or a transition from level road to steep incline), evaporative cooling performance may be optimized by applying a deep learning-based (RNN) time-series algorithm that reflects a result of the learning in real time.

According to the example, when the outside temperature is high (e.g., 35° C., 38° C., or 40° C.) and when the cell stack of the fuel cell 110 is driven under high load and thus the temperature of the outlet of the cell stack is high (e.g., 80° C.), the spray liquid is sprayed to a high-temperature area of the front side of the radiator 130. In this case, using the RNN, it is possible to implement conditions under which the spray liquid is maximally evaporated upon contact with high-temperature fins/tubes of the radiator 130, thereby improving cooling performance using evaporative latent heat of the water. As shown in FIG. 2, if the radiator 130 includes a plurality of radiators, the temperature of the air that has passed through the first radiator RAD1 may be lowered, for example, from 60° C. to 50° C., or from 55° C. to 45° C., and accordingly, the heat-dissipation cooling performance of the second radiator RAD2 may also be improved.

The amount of product water RW is much less than the amount of water actually required to be sprayed to the radiator 130 (e.g., the available product water may be only 30%-40% of the ideal spray requirement). In consideration thereof, according to the example, the spray amount is variably adjusted depending on the driving conditions and situations (e.g., steep uphill driving requiring higher cooling, low-speed city driving requiring minimal spray). Accordingly, the amount of spray liquid wasted without being evaporated may be minimized, and the storage capacity of the water tank 120 may be minimized.

In addition, according to the example, the spray amount may be variably adjusted based on a signal (e.g., temperature, flow rate, or pressure sensor data, etc.) containing information on the temperature or the flow rate output from the vehicle 100 and the fuel cell 110 depending on the driving conditions and situations of the vehicle 100.

Consequently, the fuel cell vehicle and the method of cooling the same based on artificial intelligence according to the examples have the following various advantages.

It may be possible to reduce the size of the radiator 130 and the capacity of the driving system such as the fan 180 by utilizing the evaporative cooling effect and increasing the cooling performance, thereby reducing the manufacturing costs and the weight of the fuel cell vehicle 100.

In addition, the cooling performance may be increased under the condition of the same power consumption of the fan, whereby the RPM of the fan 180 may be reduced, the marketability, energy efficiency, and driving range of the vehicle may be improved. Particularly, it may be possible to prevent the product water of the fuel cell from being discharged onto the road and forming ice on the road in winter (e.g., at ambient temperatures of −5° C., −10° C., or lower), thereby reducing the risk of traffic accidents. As a result, the marketability of the vehicle may be further improved.

In addition, according to the example, the insufficient product water may be used as appropriately as possible by optimizing the evaporative cooling performance. The optimal use of the product water may lead to minimization in the capacity of the water tank 120, which is a tank storing water discharged from the fuel cell.

As is apparent from the above description, according to a fuel cell vehicle and a method of cooling the same based on artificial intelligence according to examples, it may be possible to reduce the size of a radiator and the capacity of a driving system such as a fan by utilizing an evaporative cooling effect and increasing cooling performance, thereby reducing the manufacturing costs and the weight of a fuel cell vehicle. Because the cooling performance is increased under the condition of the same power consumption of the fan, the RPM of the fan, the marketability of the vehicle, the efficiency of use of electricity of the vehicle, and the range of the vehicle may be improved. In addition, it may be possible to prevent product water of a fuel cell from being discharged onto the road and forming ice on the road in winter (e.g., during overnight parking in subzero temperatures), thereby reducing the risk of traffic accidents and improving the marketability of the vehicle. In addition, insufficient product water may be used as appropriately as possible by optimizing the evaporative cooling performance, and the optimal use of the product water may lead to minimization in the capacity of a water tank, which is a tank storing water discharged from the fuel cell.

However, the effects achievable through the disclosure are not limited to the above-mentioned effects, and other effects not mentioned herein will be clearly understood by those skilled in the art from the above description.

FIG. 9 shows an example computing system (e.g., a computing device of a vehicle or any other apparatus). One or more controllers, processors, etc. described herein, such as one or more components of the vehicle 100, and any other components and devices disclosed herein, may be implemented by or in the computing system as shown in FIG. 9.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to an example, an artificial intelligence-based cooling method performed by a fuel cell vehicle including a fuel cell configured to discharge product water as a by-product of generation of power, a radiator configured to dissipate heat from cooling water having cooled the fuel cell, and a spray unit configured to spray the product water to the radiator as spray liquid may include acquiring sets of vehicle information, learning an evaporation rate of the spray liquid evaporated from the radiator for each set of vehicle information changing over time while varying a spray amount of the spray liquid to update a table containing the evaporation rate mapped to each set of vehicle information, adjusting the spray amount so as to maximize the evaporation rate recorded in the updated table, and spraying the spray liquid to the radiator in the adjusted spray amount.

In an example, the sets of vehicle information may include a driving speed of the fuel cell vehicle and humidity of air flowing to the radiator.

In an example, updating the table may include obtaining the evaporation rate of the spray liquid evaporated from the radiator through a recurrent neural network (RNN) using the sets of vehicle information as an input and updating a default value in the table using the evaporation rate, and a weight of each of nodes of the RNN may be optimized so as to minimize an error as follows:

$$RSME = \sqrt{\frac{1}{m} {\sum }_{i = 1}^{m} {‖ {y}^{( i )} - {\hat{y}}^{( i )} ‖}^{2}}$$

where, RMSE represents the error as a root mean square deviation, m represents the number of times by which the evaporation rate is obtained for each vehicle condition, y(i) represents a maximum amount of heat capable of being dissipated from the radiator by the spray liquid, and ŷ⁽ⁱ⁾ represents an actual amount of heat dissipated from the radiator.

In an example, the default value in the table may be a value determined by experimentally obtaining the evaporation rate in advance for each set of vehicle information.

In an example, the sets of vehicle information input to the nodes may include at least one of the temperature of the cooling water, the flow rate of the cooling water, the temperature of atmosphere around the vehicle, or the spray amount.

In an example, adjusting the spray amount may be performed using a reinforcement learning method configured to perform compensation when the evaporation rate is improved and perform penalization when the evaporation rate is deteriorated.

In an example, adjusting the spray amount may include increasing the spray amount if the evaporation rate exceeds a maximum value in the table, reducing the spray amount if the evaporation rate is less than a minimum value in the table, and maintaining the spray amount if the evaporation rate is greater than or equal to the minimum value and less than or equal to the maximum value in the table.

In an example, adjusting the spray amount may further include updating the table so as to reflect the increased or reduced spray amount.

In an example, the method may include measuring the spray amount of the spray liquid to the radiator, obtaining evaporative latent heat of the spray liquid using the measured spray amount, measuring a first temperature of cooling water flowing into the radiator and a second temperature of cooling water discharged from the radiator, obtaining an increasing amount of heat dissipation, corresponding to a difference between heat dissipation amounts before and after spraying the spray liquid, using the amount of the cooling water and the first and second temperatures, and determining whether a ratio of the increasing amount of heat dissipation to the evaporative latent heat is less than a first reference value. If the ratio of the increasing amount of heat dissipation to the evaporative latent heat is less than the first reference value, the evaporation rate may be determined to be less than the minimum value.

In an example, the amount of the cooling water used to obtain the increasing amount of heat dissipation may be predicted using a map indicating a flow rate for each RPM (revolutions per minute) of a water pump configured to pump the cooling water from the fuel cell.

In an example, the method may further include determining whether the ratio of the increasing amount of heat dissipation to the evaporative latent heat exceeds a second reference value greater than the first reference value. If the ratio of the increasing amount of heat dissipation to the evaporative latent heat exceeds the second reference value, the evaporation rate may be determined to exceed the maximum value.

In an example, if the ratio of the increasing amount of heat dissipation to the evaporative latent heat is greater than or equal to the first reference value and less than or equal to the second reference value, the evaporation rate may be determined to be greater than or equal to the minimum value and less than or equal to the maximum value.

According to another example, a fuel cell vehicle configured to perform a cooling method based on artificial intelligence may include a fuel cell configured to discharge product water as a by-product of generation of power, a radiator configured to dissipate heat from cooling water having cooled the fuel cell, a water tank configured to store the product water, a spray unit configured to spray the product water stored in the water tank to the radiator as spray liquid at a flow rate corresponding to a control signal, an information acquisition unit configured to acquire sets of vehicle information, and a controller configured to learn an evaporation rate of the spray liquid evaporated from the radiator for each set of vehicle information changing over time while varying a spray amount of the spray liquid to update a table containing the evaporation rate mapped to each set of vehicle information, adjust the spray amount so as to maximize the evaporation rate recorded in the updated table, and output the control signal generated corresponding to the adjusted spray amount to the spray unit.

In an example, the controller may include a storage unit configured to store the table, a table update unit configured to read the table stored in the storage unit and update the read table, and a spray amount adjustment unit configured to adjust the spray amount using the updated table and generate the control signal in accordance with a result of adjustment.

In an example, the radiator may include a first radiator disposed at a front side of the fuel cell vehicle and configured to be directly cooled by the spray liquid and a second radiator disposed behind the first radiator and configured to be cooled by air having passed through the first radiator.

In an example, the information acquisition unit may include a humidity sensing unit configured to sense humidity (where the humidity being relative humidity) of air flowing to the radiator and a speed measurement unit configured to measure the driving speed of the fuel cell vehicle.

In an example, the information acquisition unit may further include a flow rate sensing unit configured to sense the spray amount.

The above-described various examples may be combined with each other without departing from the scope of the present disclosure unless they are incompatible with each other.

In addition, for any element or process that is not described in detail in any of the various examples, reference may be made to the description of an element or a process having the same reference numeral in another example, unless otherwise specified.

While the present disclosure has been particularly shown and described with reference to examples thereof, these examples are only proposed for illustrative purposes, and do not restrict the present disclosure, and it will be apparent to those skilled in the art that various changes in form and detail may be made without departing from the essential characteristics of the examples set forth herein. For example, respective configurations set forth in the examples may be modified and applied. Further, differences in such modifications and applications should be construed as falling within the scope of the present disclosure as defined by the appended claims.

What is claimed is:

1. A method performed by an apparatus of a vehicle, the method comprising:
obtaining a plurality of sets of vehicle information about the vehicle;
for each set of the plurality of sets of vehicle information changing over time, determining an evaporation rate of spray liquid evaporated from a radiator of the vehicle with varying a spray amount of the spray liquid, wherein the spray liquid is drawn from product water discharged from a fuel cell of the vehicle as a by-product of generation of power, wherein the radiator is configured to dissipate heat from cooling water having cooled the fuel cell, and wherein the product water is sprayed by a nozzle of the vehicle, as the spray liquid, to the radiator;
updating a table of the vehicle recording the evaporation rate, wherein the evaporation rate is mapped to corresponding set of vehicle information of the plurality of sets of vehicle information;
adjusting the spray amount so as to maximize the evaporation rate recorded in the updated table; and
spraying the product water to the radiator at the adjusted spray amount.

2. The method according to claim 1, wherein the plurality of sets of vehicle information comprise a driving speed of the vehicle and humidity of air flowing to the radiator.

3. The method according to claim 2, wherein updating the table comprises:
obtaining the evaporation rate based on a recurrent neural network (RNN) using the plurality of sets of vehicle information as an input to the RNN, wherein the RNN comprises a plurality of nodes; and
updating a default value in the table using the evaporation rate,
wherein a weight of each of the plurality of nodes of the RNN is adjusted so as to minimize an error as follows:
$$RSME = \sqrt{\frac{1}{m} {\sum }_{i = 1}^{m} {‖ {y}^{( i )} - {\hat{y}}^{( i )} ‖}^{2}}$$
where, RMSE represents the error as a root mean square deviation, m represents a number of times by which the evaporation rate is obtained for each vehicle condition, y⁽ⁱ⁾ represents a maximum amount of heat capable of being dissipated from the radiator by the spray liquid, and ŷ⁽ⁱ⁾ represents an actual amount of heat dissipated from the radiator.

4. The method according to claim 3, wherein the default value in the table is a value determined by experimentally obtaining the evaporation rate in advance for each set of vehicle information of the plurality of sets of vehicle information.

5. The method according to claim 3, wherein the plurality of sets of vehicle information as the input to the RNN comprise at least one of:
a temperature of the cooling water,
a flow rate of the cooling water,
a temperature of atmosphere around the vehicle, or
the spray amount.

6. The method according to claim 1, wherein the adjusting of the spray amount is performed using a reinforcement learning configured to perform compensation when the evaporation rate is increased and perform penalization when the evaporation rate is decreased.

7. The method according to claim 6, wherein the adjusting of the spray amount comprises:
increasing the spray amount based on the evaporation rate exceeding an upper limit value in the table;
reducing the spray amount based on the evaporation rate being less than a lower limit value in the table; and
retaining the spray amount based on the evaporation rate being greater than or equal to the lower limit value and less than or equal to the upper limit value.

8. The method according to claim 7, wherein the adjusting of the spray amount further comprises updating the table based on the increasing or decreasing of the spray amount.

9. The method according to claim 7, comprising:
measuring the spray amount of the spray liquid to the radiator;
obtaining, based on the measured spray amount, evaporative latent heat of the spray liquid;
measuring a first temperature of cooling water flowing into the radiator and measuring a second temperature of cooling water discharged from the radiator;
obtaining an increasing amount of heat dissipation, based on an amount of the cooling water and the first and second temperatures, wherein the increasing amount of heat dissipation corresponds to a difference between heat dissipation amounts before and after spraying the spray liquid;
determining whether a ratio of the increasing amount of heat dissipation to the evaporative latent heat is less than a first reference value; and
based on the ratio being less than the first reference value, determining the evaporation rate as being less than the lower limit value.

10. The method according to claim 9, further comprising:
determining a predicted amount of the cooling water used to obtain the increasing amount of heat dissipation using a map indicating a flow rate for each revolutions per minute of a water pump of the vehicle, and wherein the water pump is configured to pump the cooling water from the fuel cell.

11. The method according to claim 9, further comprising:
determining whether the ratio of the increasing amount of heat dissipation to the evaporative latent heat exceeds a second reference value that is greater than the first reference value,
based on the ratio exceeding the second reference value, determining the evaporation rate as exceeding the upper limit value.

12. The method according to claim 11, further comprising, based on the ratio being greater than or equal to the first reference value and less than or equal to the second reference value, determining the evaporation rate as being greater than or equal to the lower limit value and less than or equal to the upper limit value.

13. A vehicle comprising:
a fuel cell configured to discharge product water as a by-product of generation of power;
a radiator configured to dissipate heat from cooling water having cooled the fuel cell;
a water tank configured to store the product water;
a nozzle configured to spray the product water stored in the water tank to the radiator as spray liquid at a flow rate corresponding to a control signal;
an information acquisition unit configured to obtain a plurality of sets of vehicle information about the vehicle; and
a controller circuit configured to cause the vehicle to:
for each set of the plurality of sets of vehicle information changing over time, determine an evaporation rate of spray liquid evaporated from the radiator with varying a spray amount of the spray liquid,
update a table of the vehicle recording the evaporation rate, wherein the evaporation rate is mapped to corresponding set of vehicle information of the plurality of sets of vehicle information,
adjust the spray amount so as to maximize the evaporation rate recorded in the updated table, and
output the control signal indicating the adjusted spray amount to the nozzle.

14. The vehicle according to claim 13, wherein the controller circuit is configured to cause the vehicle to:
store the table in a memory,
retrieve the table stored in the memory and update the retrieved table,
adjust the spray amount using the updated table, and
generate, based on the adjusted spray amount, the control signal.

15. The vehicle according to claim 13, wherein the radiator comprises:
a first radiator disposed at a front side of the vehicle, wherein the first radiator is configured to be cooled by at least a portion of the spray liquid; and
a second radiator disposed behind the first radiator, wherein the second radiator is configured to be cooled by air having passed through the first radiator.

16. The vehicle according to claim 13, wherein the information acquisition unit is configured to cause the vehicle to:
sense humidity (where the humidity being relative humidity) of air flowing to the radiator, and
measure a driving speed of the vehicle.

17. The vehicle according to claim 16, wherein the information acquisition unit is configured to cause the vehicle to sense the spray amount.

18. A vehicle comprising:
a fuel cell configured to generate electrical power and discharge product water;
a radiator configured to dissipate heat from cooling water having cooled the fuel cell;
a water tank configured to store the product water;
a nozzle configured to spray the product water toward the radiator; and
a controller circuit configured to cause the vehicle to:
obtain a plurality of sets of vehicle information,
for each set of the plurality of sets of vehicle information, based on varying a spray amount of the product water, determine an evaporation rate of the product water sprayed from the nozzle and evaporated from the radiator,
update a table mapping the evaporation rate to the corresponding set of vehicle information,
adjust, based on the updated table, the spray amount to increase the evaporation rate, wherein the spray amount is increased based on the evaporation rate exceeding an upper limit value of the table, wherein the spray amount is decreased based on the evaporation rate being less than a lower limit value of the table, and wherein the spray amount is retained based on the evaporation rate being between the lower limit value and the upper limit value; and
control the nozzle to spray the product water to the radiator at the adjusted spray amount.

19. The vehicle of claim 18, wherein the controller circuit is configured to cause the vehicle to obtain the plurality of sets of vehicle information comprising at least one of:
a driving speed of the vehicle,
a humidity of air flowing to the radiator,
a temperature of cooling water flowing to the radiator,
a flow rate of the cooling water,
an ambient temperature of air flowing to the radiator, or
a spray amount of the product water.

20. The vehicle of claim 18, wherein the evaporation rate indicates an evaporation rate associated with the sprayed product water being turned into vapor after being sprayed to the radiator, and wherein the controller circuit is configured to cause the vehicle to:
measure a temperature of cooling water flowing into the radiator and a temperature of cooling water discharged from the radiator,
based on a flow rate of the cooling water and the measured temperatures of the cooling water, determine an increasing amount of heat dissipation of the radiator,
determine a ratio of the increasing amount of heat dissipation to an evaporative latent heat of the sprayed product water, wherein the evaporative latent heat corresponds to an amount of heat required to convert the sprayed product water from a liquid state to a vapor state without a change in temperature of the sprayed product water, and
adjust, based on the ratio, the spray amount of the product water.
